(19) United States
(12) Patent Application Publication
(10) Pub. No.: US 2013/0279409 A1
(43) Pub. Date: Oct. 24, 2013

(54) Establishing a Mesh Network

(71) Applicant: DRAKER, INC., Austin, TX (US)

(72) Inventors: Wilbur L. Dublin, III, Austin, TX (US); Donald J. Davis, Austin, TX (US); Thadeus N. Burgess, Austin, TX (US)

(73) Assignee: Draker, Inc., Austin, TX (US)

(21) Appl. No.: 13/856,533

(22) Filed: Apr. 4, 2013

Related U.S. Application Data
(60) Provisional application No. 61/635,032, filed on Apr. 18, 2012.

(51) Int. Cl. H04W 40/02

(52) U.S. Cl. CPC H04W 40/02
USPC 370/328

(57) ABSTRACT

Establishing a mesh network. A gateway in the mesh network may broadcast a wireless message to neighboring nodes of the gateway in the mesh network. The neighboring nodes may store first hop count information based on the wireless message received from the gateway. The neighboring nodes may each broadcast the wireless message to other neighboring nodes in the wireless mesh network. The other neighboring nodes may store second hop count information based on the received messages from the respective neighboring nodes. The second hop count information may indicate a greater hop count than the first hop count information. The first hop count information and the second hop count information may be used to establish routes from nodes to gateways in subsequent communications in the mesh network.

### PRIORITY INFORMATION

The present application claims benefit of priority to U.S. Provisional Ser. No. 61/635,032, filed on Apr. 18, 2012, titled “Establishing and Communicating Data in a Mesh Network”, whose inventors are Wilbur L. Dublin, III, Donald J. Davis, and Thadeus N. Burgess, and which is hereby incorporated by reference in its entirety, as if fully and completely set forth herein.

### FIELD OF THE INVENTION

The present invention relates generally to mesh networks, and more particularly to a system and method for establishing and communicating data in a mesh network.

### DESCRIPTION OF THE RELATED ART

Mesh networks are often used in situations where each node not only captures and disseminates its own data, but also serves as a relay for other nodes. Mesh networks can be wired or wireless, as desired. There are a variety of methods for establishing mesh networks and communicating data within the network once established. However, current methods generally do not scale well and can have a variety of other issues, e.g., inefficient memory use, over-burdensome routing requirements, etc. Accordingly, improvements in mesh networks are desired.

### SUMMARY OF THE INVENTION

Various embodiments are presented of a system and method for establishing and communicating data in a mesh network. In some embodiments, the mesh network may be a wireless mesh network, although wired mesh networks are also envisioned.

Initially, a gateway in a wireless mesh network may broadcast a wireless message to neighboring nodes of the gateway in the wireless mesh network. The neighboring nodes may accordingly store first hop count information based on the wireless message received from the gateway.

In response to the wireless message, the neighboring nodes may each rebroadcast the wireless message to other neighboring nodes in the wireless mesh network. Accordingly, the other neighboring nodes may store second hop count information based on the received messages from the respective neighboring nodes. The second hop count information may indicate a greater hop count than the first hop count information.

This process may be repeated for each set of nodes, e.g., until all nodes in the mesh network have received the original broadcast message. Note that each node may determine or transmit additional information. For example, the original broadcasted message may indicate a current time or may otherwise be used for time synchronization. Additionally, each node may indicate its current transmission queue length or “backpressure”. This information may be usable by later nodes, which receive the broadcast from the respective node, for determining communication routes (e.g., preferred or optimal communication routes). Further, each node may determine the signal strength of each received information, e.g., which may also be used for determining communication routes of information. Note that the above procedure may be performed a plurality of times, e.g., every 10 seconds, 15 seconds, 30 seconds, 45 seconds, 1 minute, 2 minutes, 5 minutes, etc., such as during operation of the mesh network.

Thus, after the performing the procedure indicated above, each node may be aware of neighboring nodes that it is able to communicate with, as well as the hop count of the neighboring nodes. In one embodiment, each node may maintain a routing table of all neighboring nodes, or a subset of neighboring nodes, e.g., all or a threshold number of nodes which have an equal or lower hop count than the node. In addition to the hop count information, each node may also store information regarding the queue length or backpressure of the nodes in the routing table and/or information regarding the signal strength of the nodes in the routing table.

When a first node wishes to transmit information (e.g., local measurement data of the node), it may use the information stored in the routing table to determine a neighbor for receiving the transmission. The first node may at least use the hop count information to determine the neighbor. In one embodiment, the first node may score each node in its routing table based on hop count, back pressure, and/or signal strength (e.g., with priority or weight in that order). The first node may only send the data to neighboring nodes with a hop count less than (or, in some cases, equal to) its own hop count. Note that in this embodiment, the gateway has the lowest possible hop count and lower hop counts corresponds to the node being closer to the gateway; however, other hop count systems may also be used, with corresponding changes to the described embodiments. Generally, “lateral” transmissions to nodes of equal hop count may only be permissible where lower hop count routes are not available. However, such situations are typically temporary where routes (and their related hop counts) may not have fully propagated and converged.

Once a next hop node has been selected, the first node may perform a unicast transmission to the selected node. If the selected node successfully receives the data, it may provide an acknowledgement back to the first node. If the first node does not receive an acknowledgement, then it may select a new next hop node and transmit to the new node.

Once the data has been successfully received by a new node, it may perform the same procedure again, until the data is successfully transmitted to the gateway, which may have the lowest hop count (e.g., with a value of zero). The gateway may then provide the data to a computer system (e.g., a server) over a network (e.g., a local area network (LAN) and/or wide area network (WAN)).

The procedure described above may be performed simultaneously by a plurality of different nodes within the mesh network. In a wireless mesh network, the transmission power may be selected (e.g., by configuration or automatically, as desired) in order to limit interference to other nodes in the wireless mesh network, e.g., such that transmissions are limited in distance to reach only neighboring nodes.

### BRIEF DESCRIPTION OF THE DRAWINGS

A better understanding of the present invention can be obtained when the following detailed description of the preferred embodiment is considered in conjunction with the following drawings, in which:

FIG. 1 illustrates an exemplary system that may implement various described embodiments;

FIG. 2 illustrates a specific solar panel system that may implement various described embodiments;

FIG. 3 is a block diagram of a wireless node, according to one embodiment;

FIG. 4 is a flowchart diagram illustrating one embodiment of establishing a mesh network;

FIG. 5 is a flowchart diagram illustrating one embodiment of communicating in a mesh network;

FIGS. 6A-6K and 7A-7Z illustrate exemplary establishment and communication in a mesh network, according to the embodiments of FIGS. 4 and 5;

FIGS. 8A-8E illustrate tables corresponding to an embodiment of node selection;

FIGS. 9A-9H illustrate exemplary wireless mesh networks, according to various embodiments; and

FIGS. 10A-10C illustrate exemplary message formats, according to one embodiment.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE INVENTION

### Terms

The following is a glossary of terms used in the present application:

Memory Medium—Any of various types of memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, Rambus RAM, Ferromagnetic RAM (FRAM), etc.; a non-volatile memory such as a Flash memory, EEPROM, magnetic media, e.g., a hard drive, or optical storage; registers, or other similar types of memory elements, etc. The memory medium may comprise other types of memory as well or combinations thereof. In addition, the memory medium may be located in a first computer in which the programs are executed, or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—a memory medium as described above, as well as a physical transmission medium, such as a bus, network, and/or other physical transmission medium that conveys signals such as electrical, electromagnetic, or digital signals.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions taken by the user or by other elements of the system.

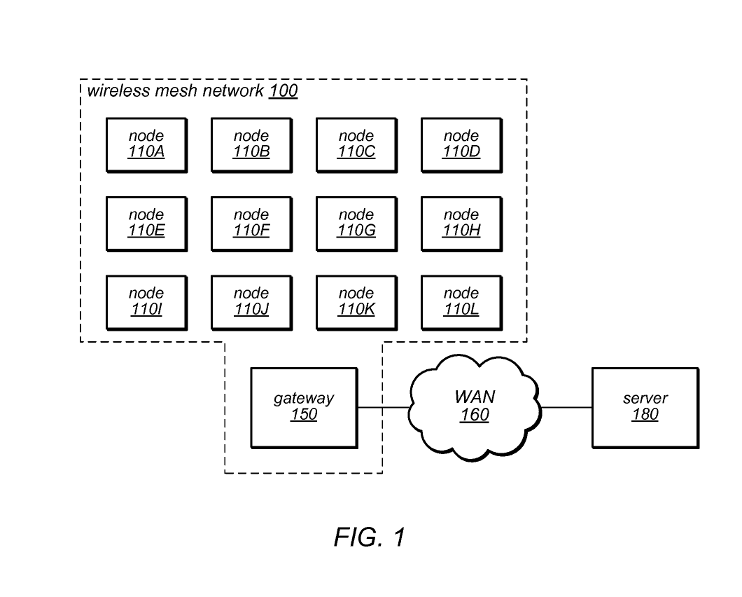

### FIG. 1—Exemplary System

FIG. 1 illustrates an exemplary system including a mesh network 100, according to one embodiment. The mesh network 100 may be implemented as a wired or wireless mesh network, as desired. Note that in the following descriptions, the mesh network 100 will be described as a wireless mesh network, but in alternative embodiments, it may be modified to operate as a wired mesh network.

As shown, the wireless mesh network (WMN) 100 includes a plurality of nodes 110A-110L (referred to in plural as “nodes 110”) as well as a gateway 150. As also shown, the gateway 150 is coupled to a wide area network (WAN) 160, such as the Internet. Additionally, a server (or a plurality of servers) 180 may also be coupled to the WAN 160. In some embodiments, data originated by the nodes 110 may be initially provided to the gateway 150 within the WMN 100, which in turn may provide the data to the server 180 over the WAN 160.

Generally, nodes 110 in the WMN 100 may transmit data (e.g., measured or received by the nodes 110) within the WMN 100 with a final destination of the gateway 150. For example, node 110A may transmit data to node 110E, which may in turn transmit data to node 110I. Node 110I may be close enough to transmit the data to gateway 150 or the data may be transferred to node 110J first, depending on the node proximity and/or wireless signal strength. Finally, gateway 150 may transmit the data to server 180 via the WAN 160. This process may be repeated for any of the nodes 110 in the WMN 100.

Further details on establishing the WMN 100 and performing data transfers within the WMN 100 are provided below.

The exemplary system, and particularly the WMN 100, may be used in any of a variety of applications. For example, the WMN 100 may be particularly useful for measurement applications where the nodes 110 receive measurement data (e.g., from data acquisition or measurement devices) for transmission.

In general, the WMN 100 may be used in any application in which current mesh networks are used, and may be particularly well-suited to applications such as wireless sensor network in which the direction of data flow is largely in one direction (e.g., measured sensor data flowing from the mesh to another network via a gateway). Networks of this type may be referred to as “penunidirectional” (“nearly”, or “next to” unidirectional) networks because, although such networks support data flow in both directions, they may be particularly useful for asymmetric data flows that are principally in one direction at a time in a given application.

Because of this penunidirectional attribute, the WMN 100 may be highly suited for many distributed monitoring and control applications such as building monitoring and control (including lighting, HVAC, security monitoring, and other building systems), industrial and manufacturing monitoring and control, advertising networks for the delivery of targeted advertisement content, ad hoc subscription to information feeds (e.g., near real time, such as sports scores and statistics to seat or handheld devices in an arena setting, or more static, such as place-based information, e.g., as “augmented reality” descriptions of historical sites or museum exhibit), security and perimeter defense networks, ad-hoc workgroup communications for use in military operations, field service and support, and other activities where information transfer typically favors one direction at a time. However, it should be noted that embodiments described herein provides mechanisms for partial and/or local optimization of data flows in the non-optimal direction as well, and that these mechanisms can provide all required communications in a majority of cases.

As discussed below, the WMN 100 may be particularly useful for systems for solar panel monitoring and control.

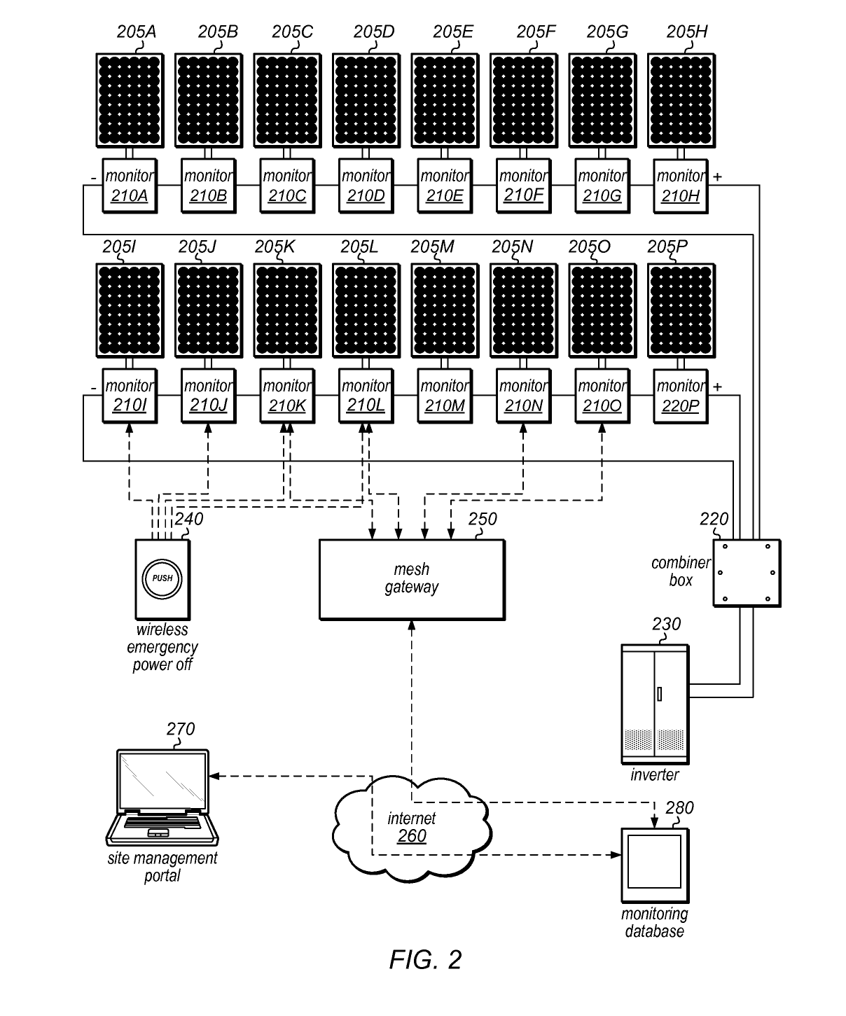

### FIG. 2—Exemplary Solar Panel System

FIG. 2 illustrates a particular embodiment of a system including a WMN. In this embodiment, the WMN is used for a solar panel array. In this embodiment, the monitors 210 and gateway 250 may correspond to the WMN 100 of FIG. 1.

In the exemplary system of FIG. 2, a plurality of solar panels are coupled to various devices, which may be configured to implement embodiments described herein. More specifically, a first string of solar panels 205 A-H and a second string of solar panels 105 I-P (forming a solar panel array) may provide DC power to combiner 220, which may in turn provide the power from the solar panel array to inverter 230, which may convert the provided DC power to AC power. The inverter 230 may provide the converted power to various power sinks (e.g., a power grid, a local system, such as a house or building, a battery system, etc.).

As shown, each solar panel 205 A-P may be coupled to a respective monitor 210 A-P (corresponding to nodes 110 of FIG. 1). Each monitor may be configured to receive the DC power from each panel and provide the power to the combiner 220, although the combiners may be optional. As also shown, the monitors 210 may be coupled together in series (at least within each string of solar panels), although parallel or combinations of serial and parallel couplings are envisioned. Thus, each monitor 210 may receive power provided from its respective solar panel and add that power to the power of the other monitors within the string of solar panels. In some embodiments, to reduce node count and attendant cost, the string may be populated with fewer monitors 210 than the number of panels 205 in the string. With as little as one monitor, this configuration may provide a measurement of the current in the string, with bus voltage determined through another measurement, either at the inverter or through summing the voltage values of one or more fully populated reference strings.

In some embodiments, the monitor 210 may provide power optimization functionality in order to optimize or improve the power provided from solar panel 205. In some embodiments, the monitors 210 may be referred to as “optimizers”.

In addition to receiving and providing power, each monitor may be configured to gather information regarding its corresponding solar panel(s). For example, the monitor 210 may store information regarding the received current, voltage, power, etc. of its respective solar panel 205. In addition to the electric properties of the solar panels, further information may be received for the solar panel 205. For example, the monitor 210 and/or solar panel 205 may include location circuitry (e.g., GPS circuitry) for determining the location of the solar panel 205. Further, the monitor 210 and/or solar panel 205 may include RFID circuitry for providing identity and/or other information of the solar panel 205.

In one embodiment, the monitor 210 may be integrated with a solar panel 205. For example, the solar panel 205 may be configured with an integrated monitor 210, which may be located inside the panel's junction box, to provide information regarding the state of the solar panel. For example, the solar panel 205 may be configured to provide electric properties (e.g., current, voltage, power, etc.) of individual cells or groups of cells in the solar panel to the monitor 210. Further, the solar panel 205 may be configured to provide model or other identification information of the solar panel 205 (e.g., identifying the type of solar panel, such as by manufacturer, type, model number, serial number, output, configuration, temperature response, etc.), any current attributes of the solar panel 205 (e.g., a current condition of the solar panel, such as damaged, dirty, functional, bypass diode status, etc.), and/or any information pertaining to the solar panel 205 that may be of interest. Such information may be provided in any number of methods, e.g., using RFID, software, etc.

While the above describes the monitor 210 receiving or determining information regarding the solar panel 105 based on signals received from the solar panel 205, this information may be gathered or determined from sources other than the solar panel 205. For example, an external camera may be configured to monitor the solar panels 205. The external camera may provide images of the solar panels, or may perform image processing to determine whether the solar panel is currently shaded (e.g., from a nearby obstacle, such as a tree, building, etc.). Similarly, a temperature sensor may be used to measure the ambient temperature, the temperature of the respective solar panel, etc. The temperature sensor may provide such temperature information to the monitor 210, although in other embodiments, such information may be provided to other devices instead, as described below. Further, other physical or environmental parameters may be gathered, such as solar irradiance (plane-of-array or global horizontal), wind speed and direction, humidity, barometric pressure, etc. Accordingly, the monitor 210 may receive information pertaining to its respective solar panel 205 from sources other than the solar panel 205. Note that the monitor 210 may include logic (e.g., software and/or hardware) for performing any of the analysis described above, although in other embodiments, this intelligence may be performed elsewhere.

In some embodiments, rather than having a monitor 210 for each solar panel 205, a monitor 210 may be used for a plurality of solar panels 205, as desired. In such embodiments, the monitors 210 may receive and provide data for a plurality of solar panels 205 rather than a single solar panel 205.

As shown, each of the monitors 210 may be coupled to wireless emergency power off 240. The monitors 210 may be coupled to the wireless emergency power off 240 via various wireless communication methods, such as 802.15.4, Bluetooth, 802.11x (WLAN), WiMax, etc. A user may be able to shut down all or a subset of the solar panels 205 using the wireless emergency power off 240 via the monitors 210. In further embodiments, the solar panels may automatically be shut down, e.g., via the mesh gateway 250 or in response to other factors, including an emergency power off controller attached via a network, such as a conventional wired network.

In addition, the monitors 210 may be wirelessly coupled to mesh gateway 250 within a wireless mesh network. The mesh gateway may be any kind of device that is configured to receive and store information provided by the monitors 210. For example, the mesh gateway 250 may be a computer system including a processor and a memory medium, storing programs that are executable by the processor. The mesh gateway 250 may instead (or also) be a router or modem that may be able to couple to and communicate with the Internet 260. Alternatively, the mesh gateway 250 may be coupled to a local area network (LAN), which is in turn coupled to the Internet 260 (e.g., via a router/modem). Each of the monitors 210 may provide information to the mesh gateway 250 regarding the solar panels 205.

As indicated above, in one embodiment, the mesh gateway 250 may include a memory storing programs that are executable by a processor of the mesh gateway 250. The programs stored in the memory medium may include monitoring programs for monitoring the information related to the solar panels 205 (e.g., as reported by the monitors 210 or other devices), analyzing programs for analyzing the gathered information, aggregating programs for aggregating the data gathered by the monitors 210 or other devices coupled to the mesh gateway 250, and/or other types of programs, as desired. In one embodiment, the mesh gateway 250 may host a website that may be accessible by various other computer systems (such as computer system 270) to view the gathered or generated data regarding the solar panels 205. However, in alternate embodiments described below, that website may be hosted by one or more servers on the Internet 260 (e.g., cloud computers coupled to the monitoring database 280), which a user may be able to access from any location.

The mesh gateway 250 may provide the information gathered or generated regarding the solar panels 205 (e.g., as reported by monitors 210, although other gathered information is envisioned) to monitoring database 280 over the Internet. The monitoring database 280 may store all or a subset of the data regarding the solar panels 205 in the database. For example, the monitoring database 280 may store time series data of the electric property information provided by the monitors 210 or any other type of data regarding the solar panels 205. The database 280 may store the data at almost any time scale. For example, the monitoring database may include properties of each of the panels 205 every 10 seconds, 30 seconds, 1 minute, 5 minutes, 10 minutes, 30 minutes, 1 hour, 5 hours, 1 day, etc.). Similarly, other information related to the solar panels 205 may be stored at various intervals in the monitoring database 208 (note that the intervals may vary depending on the type of data being reported). The mesh gateway 250 may store several sets of data before providing them to the monitoring database 280, provide the data as it is received from the monitors 210 or other devices, and/or provide data at a periodic rate (e.g., according to how often the data is stored in the database), etc.

The monitoring database may store information for a plurality of arrays of solar panels and/or for a plurality of different sites. For example, the monitoring database may have a table or identification associated with the site shown in FIG. 2. The monitoring database may have a separate table or identification associated with another site (which may be similarly configured). Thus, the monitoring database may include information associated with a plurality of different sites, which may be viewed by a plurality of different users, e.g., each associated with one or more sites, as desired.

One or more servers may be coupled to monitoring database 280. The servers may be configured to host a website so that users can view data associated with the solar panels at one or more sites. For example, a user or administrator associated with the site of FIG. 2 may be able to log in to the website to view information associated with that site's solar panels (or other information associated with the site). Other users may be able to view information associated with other site's solar panels. In alternate embodiments, rather than using a website, a client may execute an application which retrieves information from the monitoring database 280 (e.g., via the one or more servers) and provides the information in a graphical user interface of the application. Users may use any of various devices for viewing data associated with (or even managing) the solar panels 210 at the site. In the embodiment of FIG. 2, a user may use laptop 270 to access the site management portal provided by the servers for the site of FIG. 2. However, almost any type of device is envisioned for accessing the data associated with the site, such as cell phones, tablet computers, netbooks, laptops, desktop computer systems, etc. Generally, any type of device may be used to view information associated with the solar panels or even manage the solar panels at the site.

Thus, FIG. 2 illustrates an exemplary solar panel system having a wireless mesh network that includes the monitors 210 and the gateway 250. Note that various ones of the devices shown in FIG. 2 may be combined, removed, or added. For example, the mesh gateway 250 may be combined with the combiner 220, the wireless emergency power off 240, the computer system 270, etc. Further, the monitoring database 280 may be included on site rather than over a wide area network, such as the Internet 260. Alternatively, or additionally, a management server or other computer system may be included at the location of the panels or elsewhere, e.g., for managing the system. Thus, multiple variations are envisioned for the exemplary system of FIG. 2.

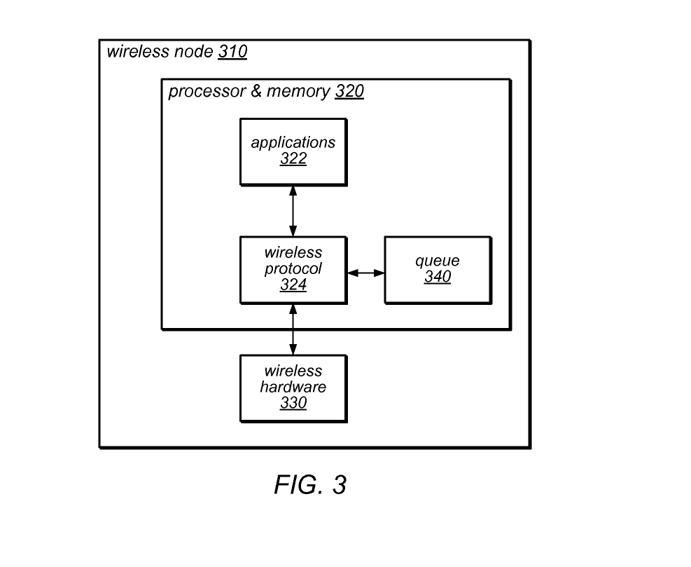

### FIG. 3—Block Diagram of Exemplary Wireless Node

FIG. 3 is a block diagram of a wireless node 310, according to one embodiment. Descriptions of the wireless node 310 may apply to the nodes 110 or the monitors 210.

As shown, the wireless node 310 may include a processor and memory 320. For example, the memory medium may store program instructions which are executed by the processor to perform the functionality of the program instructions. More specifically, the memory medium may store program instructions corresponding to applications 322 as well as wireless protocol 324. The memory medium may also store a queue 340 for storing incoming and/or outgoing messages. Generally, the applications 322 may be executable to perform functionality of the wireless node 310. For example, following the example of the solar panel system of FIG. 2, the applications 322 may be executable to receive or determine data of solar panels 205. These applications 322 may then execute to provide this data, e.g., the solar panel data, to the gateway 150, as discussed below.

Accordingly, the wireless protocol 324 may be executable to perform wireless communication using the wireless hardware 330. The wireless hardware 330 may include various low level hardware, such as wireless antennas, PHYs, MAC, etc., which may be used to perform wireless transmission of data. The wireless protocol 324 and/or wireless hardware 330 may implement any of various wireless protocols, such as 802.15.4, 802.11, Bluetooth, WiMax, LTE, etc. Generally, the wireless protocol 324 and wireless hardware 330 may operate to perform data communication in the manner described herein.

The queue 340 may store incoming and outgoing messages in a common format and buffer. The queue 340 may allow the applications 322 and the wireless hardware 330 to operate independently at a high (e.g., optimal) speed for each. Additionally, by storing all messages in the same queue 340, an incoming message to be forwarded may be handled by the wireless protocol 324 without need for copying from an incoming buffer to an outgoing buffer. However, embodiments are also envisioned where more than one queue is used.

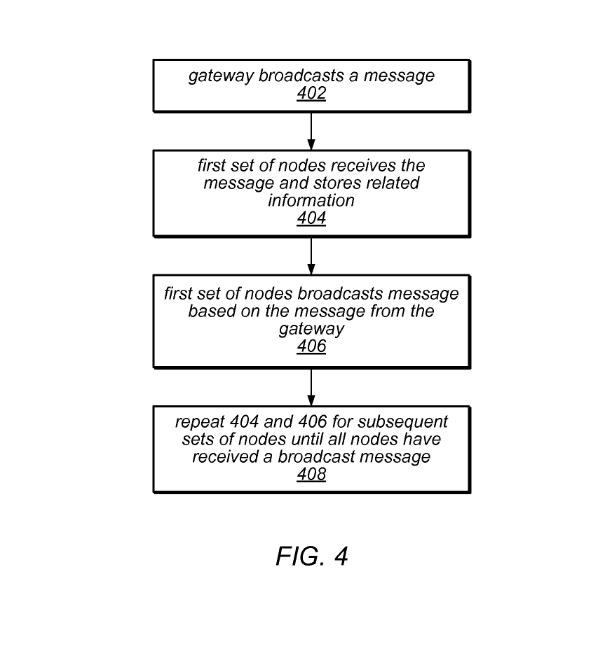

### FIG. 4—Establishing a Mesh Network

FIG. 4 illustrates a method for establishing a mesh network. The method shown in FIG. 4 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, this method may operate as follows.

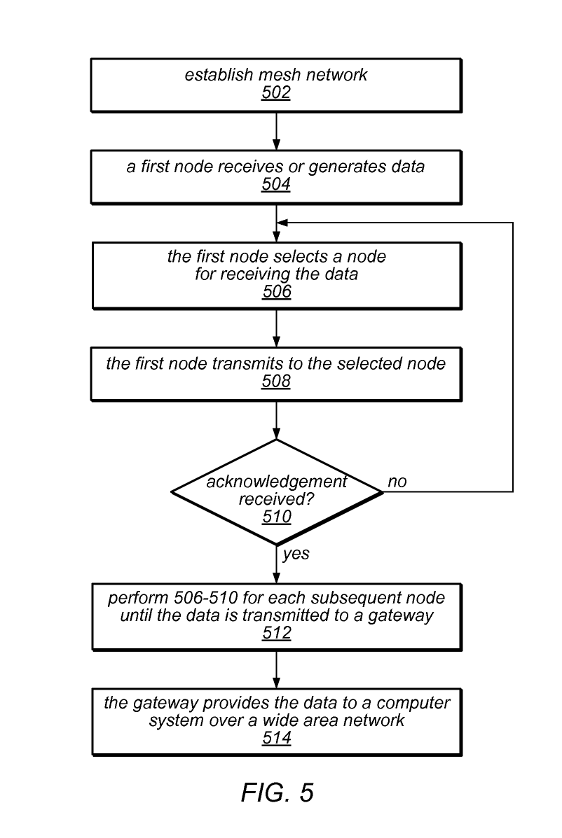

In 402, a gateway in a mesh network, or other type of sink node, may broadcast a message (e.g., wirelessly). The message may be intended for reception by nodes that are close enough to the gateway to receive the message. Those nodes that are able to receive the message from a transmitting node (in this case, the gateway) may be referred to as “neighboring nodes”. The neighboring nodes of the gateway may be referred to as a “first set of nodes” for FIGS. 4 and 5. The message may be used to establish or refresh the mesh network. The message may include various values or information related to the mesh network and/or data gathering or control functions, such as measurements or commanding remote nodes to take a particular action, respectively. For example, the message may include hop count information, e.g., indicating that the gateway has a base hop count number, such as 0. Additionally, the message may indicate information of general interest to all or a subset of nodes, such as a current time, e.g., for establishing or synchronizing the current time for each of the nodes in the mesh network, or to set parameters of general interest, e.g., for setting default power levels. In one embodiment, the message may indicate a schedule or interval for transmitting data back to the gateway (e.g., every 5 seconds, 30 seconds, 1 minute, 5 minutes, etc.). The message may further indicate a current queue length or backpressure of the transmitting node, although in the case of a gateway, the backpressure may be kept low or nonexistent, so that data always flows to the gateway. Additionally, the message may include a sequence number, e.g., which may be used to distinguish the periodic broadcasts from each other.

In 404, in response to the message of 402, the neighboring nodes of the gateway (the first set of nodes) may store information related to the mesh network, e.g., related to the gateway. More specifically, the first set of nodes may store first hop count information based on the hop count information indicated in the message. For example, the first set of nodes may include the gateway in their routing tables. In the routing table, the gateway may be listed with a hop count indicated by the hop count information, e.g., a hop count of “0”. Additionally, the first set of nodes may establish their own hop counts based on the hop count of the gateway. For example, the hop count of the first set of nodes of the gateway may be one greater than the hop count of the gateway (e.g., a hop count of “1” when the gateway has a hop count of “0”). However, alternative methods for establishing the hop counts are also envisioned.

Additionally, where the message indicates backpressure information, the first set of nodes may store a backpressure value of the gateway, e.g., in the routing table. In one embodiment, the neighboring nodes may determine signal strength information of the gateway, based on the transmitted message. Accordingly, the first set of nodes may also store the signal strength information of the gateway, e.g., in the routing table.

Further, the first set of nodes may use synchronization information to establish a current time, e.g., for time stamping measured data. As indicated above, the message from the gateway may indicate a current time. Accordingly, the first set of nodes may set their time equal to the indicated time. In some embodiments, the first set of nodes may adjust the time based on transmission times or latency. Alternatively, the time may not be adjusted, which may naturally result in offsetting transmissions of data. For example, the first set of nodes may also establish a schedule for transmitting data back to the gateway, e.g., based on a schedule or interval provided in the message by the gateway. Accordingly, in embodiments where the time is not adjusted, the time of initiation of data transmission by the nodes may increase as the number of hops or distance from the gateway increases. This can have a beneficial effect by spreading out waves of data through the mesh, thus minimizing or avoiding congestion due to a large number of nodes all attempting to transmit at the same time. If the clocks of mesh nodes are adjusted for propagation delays, an artificial delay for transmissions may be introduced to provide the same effect, e.g., a delay derived from the hop count.

In 406, the first set of nodes may each broadcast a respective message based on the message received in 404. These messages may be broadcast such that neighboring nodes of the first set of nodes receive the message. These nodes are referred to as the “second set of nodes” for FIGS. 4 and 5. Similar to the message sent by the gateway above, each of the first set of nodes may send a message that includes hop count information of the transmitting node, backpressure information of the transmitting node, schedule information (e.g., a time interval for transmitting data), and/or time information (e.g., the current time and/or the time initially sent by the gateway). As a more specific example, a first node of the first set of nodes which received the message transmitted by the gateway in 402 may generate a broadcast message in response to receiving the message received from the gateway. Following this example, the broadcast message may indicate the first node's hop count, the current back pressure or queue of the first node, and the time value sent by the gateway, and a time interval for sending data back to the gateway (e.g., every 20 seconds).

In 408, 404 and 406 may be repeated for the second set of nodes and so on, e.g., until all nodes in the mesh network have received the original broadcast message. In one embodiment, nodes having a lower hop count may ignore messages broadcasted from nodes with a higher hop count.

The above procedure may be performed a plurality of times, e.g., every 10 seconds, 15 seconds, 30 seconds, 45 seconds, 1 minute, 2 minutes, 5 minutes, etc. Accordingly, the mesh network may establish or update each time messages are broadcast throughout the network, beginning with the gateway. Thus, the network may be self correcting or self healing in the sense that any errors may be corrected the next time the procedure is performed, which may be relatively frequently. Similarly, the mesh network may remove or correct for a node failing, since it may not participate in the above procedure during the next iteration.

While the above method is described with respect to a single gateway, multiple gateways may be present in the mesh network, and the process may be used for each gateway. For example, in one embodiment, the plurality of gateways may broadcast respective messages, e.g., at the same time, such as in response to a schedule or an external message (e.g., from a server communicating with the gateways). The nodes may also be configured to ignore duplicate broadcast messages or broadcast messages from nodes which have a higher hop count than themselves. Accordingly, the hop count for each node may be assigned to the lowest appropriate hop count, thereby ensuring that hop counts are set according to the closest gateway. Thus, where a node receives a first broadcast message from a node with a hop count of 4 (corresponding to a first gateway) and a second message from a node with a hop count of 6 (corresponding to a second gateway), the node may set its hop count to the lower value (in this case, 4).

Thus, after the performing the procedure indicated above, each node may be aware of neighboring nodes that it is able to communicate with, as well as the hop count of the neighboring nodes. In one embodiment, each node may maintain a routing table of all neighboring nodes, or a subset of neighboring nodes, e.g., all or a threshold number of nodes which have an equal or lower hop count than the node. As indicated above, in addition to the hop count information, each node may also store information regarding the queue length or backpressure of the nodes in the routing table and/or information regarding the signal strength of the nodes in the routing table.

Communication with the mesh network is discussed in more detail below.

### FIG. 5—Communicating in a Mesh Network

FIG. 5 illustrates a method for communicating in a mesh network. The method shown in FIG. 5 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, this method may operate as follows.

In 502, the mesh network may be established, e.g., in the manner described in FIG. 4. More specifically, the mesh network may be configured such that each node is aware of its neighboring nodes and stores information usable for selecting at least one of its neighboring nodes for transmission of data. The information used for selection may include hop count information, queue length or backpressure, signal strength information, etc. This information may be stored in a routing table of each node. The routing table may include this information for each neighboring node having its own hop count or lower, e.g., up to a threshold number of neighboring nodes, such as 8.

In 504, a first node in the mesh network may receive or generate data. For example, the first node may be associated with one or more solar panels, such as described above regarding FIG. 2. Specifically, the data may be related to various electrical properties of the solar panel(s), conditions near the solar panel(s), and/or any desired information regarding the solar panel(s). This data may be measured directly by the first node or may be provided to the first node via a data acquisition or measurement device, e.g., which is coupled to the first node, such as in a wired manner.

The first node may be configured to provide the data to a gateway in the mesh network, e.g., for transmission to a server over a WAN. In one embodiment, the first node may be configured to provide the data according to a schedule, e.g., each time a specified time interval has passed.

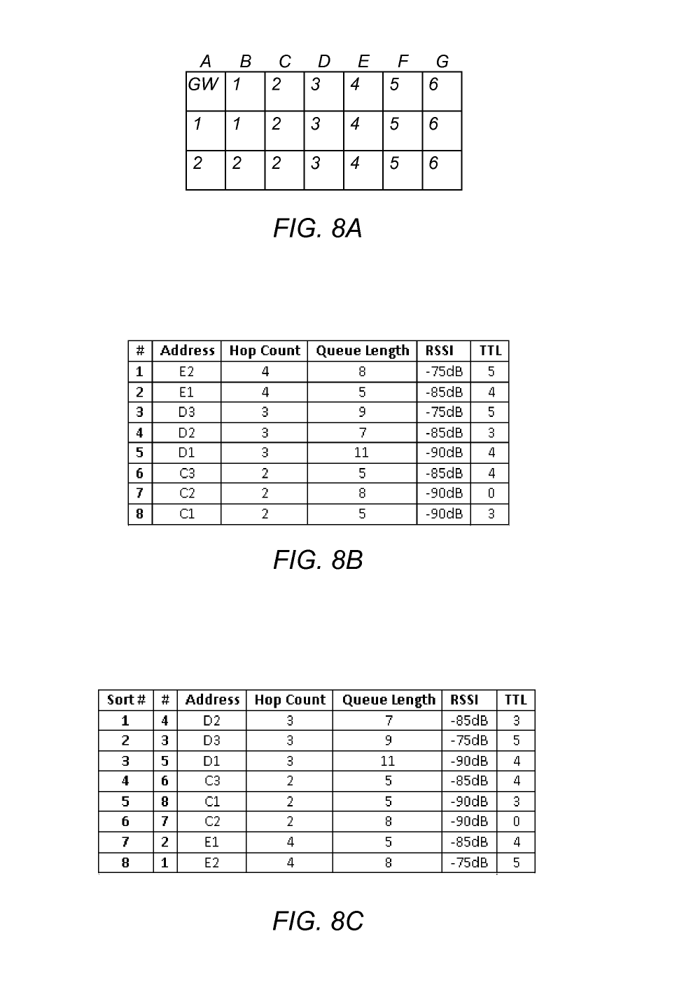

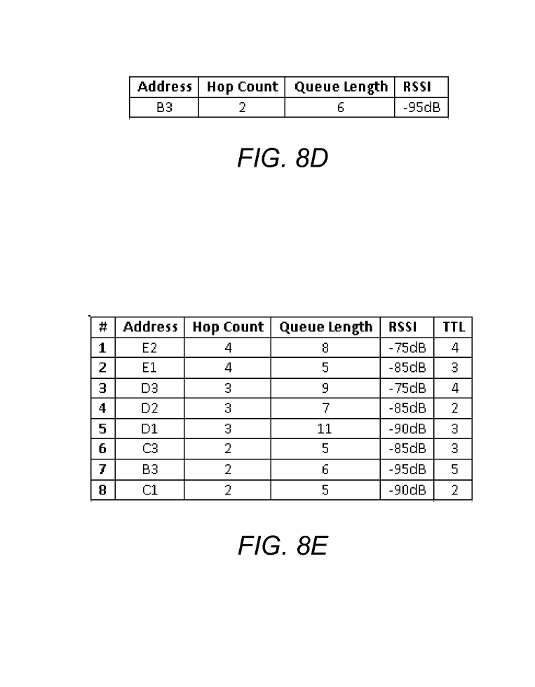

Accordingly, in 506, the first node may select a neighboring node for receiving the data from the first node. The selection may be performed using the information discussed above, which may be stored in a routing table. The first node may at least use the hop count information to determine the neighboring node. In one embodiment, the first node may score each node in its routing table based on hop count, back pressure, and/or signal strength (e.g., with priority or weight in that order). The first node may only send the data to neighboring nodes with a hop count less than (or, in some cases, equal to) its own hop count. Exemplary details of one embodiment for this selection are provided below, regarding FIGS. 8A-8E.

Once a node has been selected, in 508, the first node may perform a unicast transmission (e.g., a wireless transmission) to the selected node. The unicast transmission may be sent specifically to the selected node, e.g., using an identifier of the second node or sent in a manner such that the data is only received by the selected node. Thus, other nodes may either ignore the transmission or may not be able to receive the transmission.

If the selected node successfully receives the data, it may provide an acknowledgement back to the first node. If the first node does not receive an acknowledgement, then it may select a new node and transmit to the new node, e.g., using the next highest priority node. In one embodiment, the receiving node may not provide an acknowledgement if it did not successfully receive the data or if its queue is full (or greater than a threshold amount). Thus, in 510, the method either returns to 506 if no acknowledgement is received or continues on to 512 if the acknowledgement is received.

In 512, the method may be performed for each subsequent node until the data is successfully transmitted to the gateway, which may have the lowest hop count (e.g., with a hop count value of 0). In 514, the gateway may then provide the data to a computer system (e.g., a server) over a wide area network (WAN).

The procedure described above may be performed simultaneously by a plurality of different nodes within the mesh network. In a wireless mesh network, the transmission power may be selected (e.g., by configuration or automatically, as desired) in order to limit interference to other nodes in the wireless mesh network, e.g., such that transmissions are limited in distance to reach only neighboring nodes.

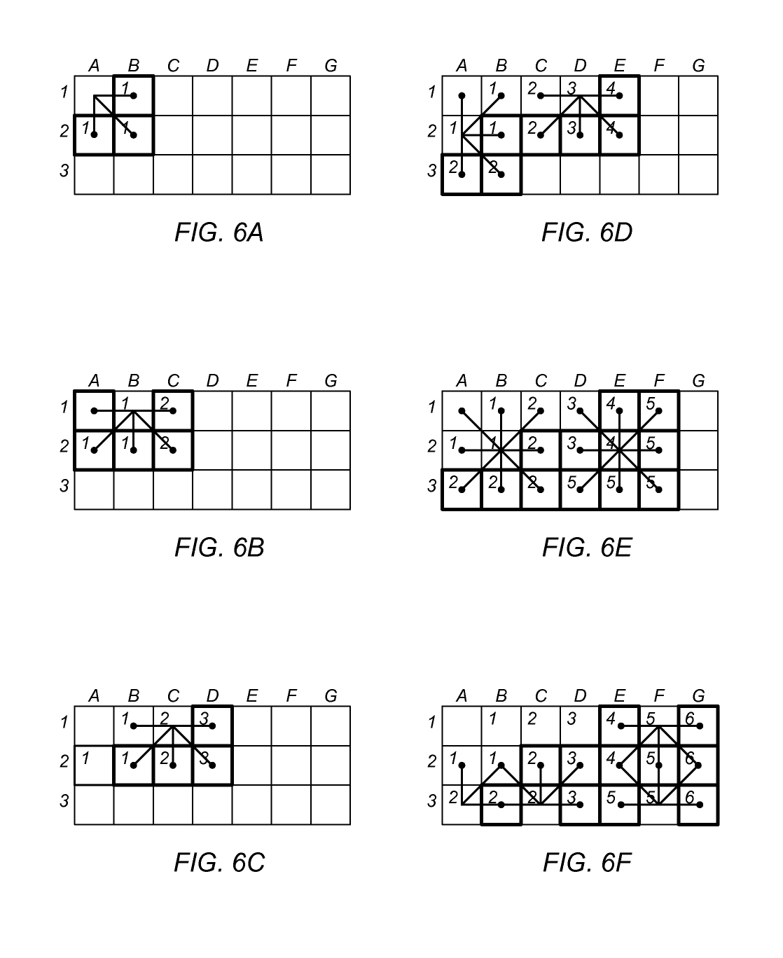

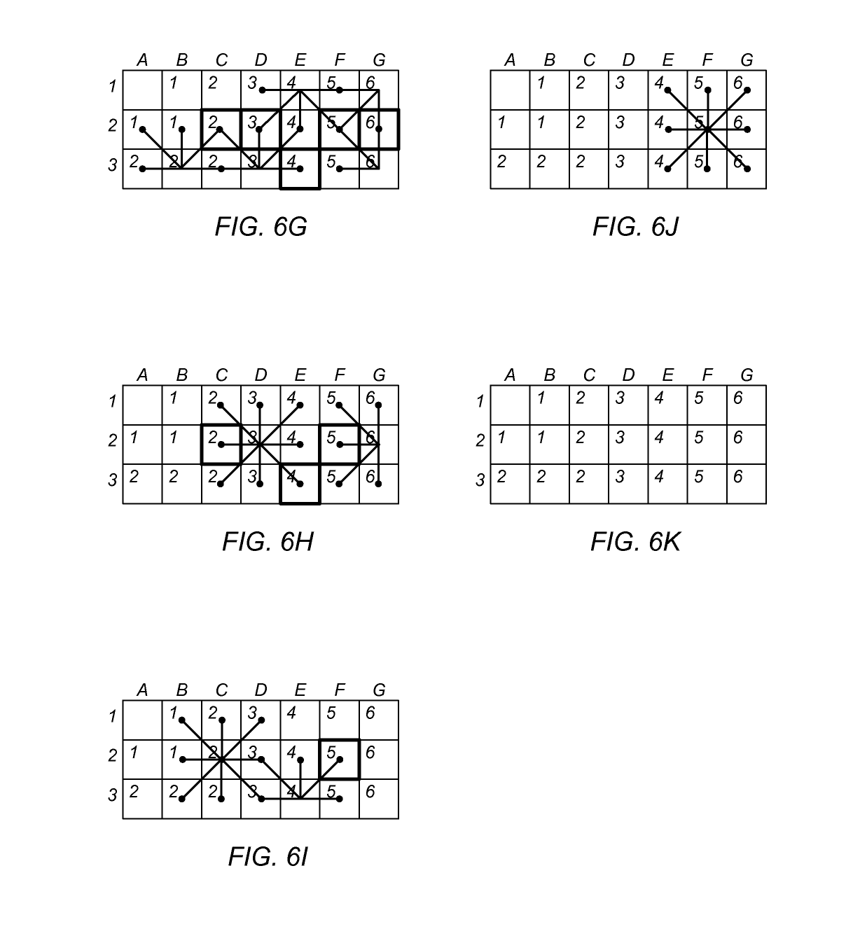

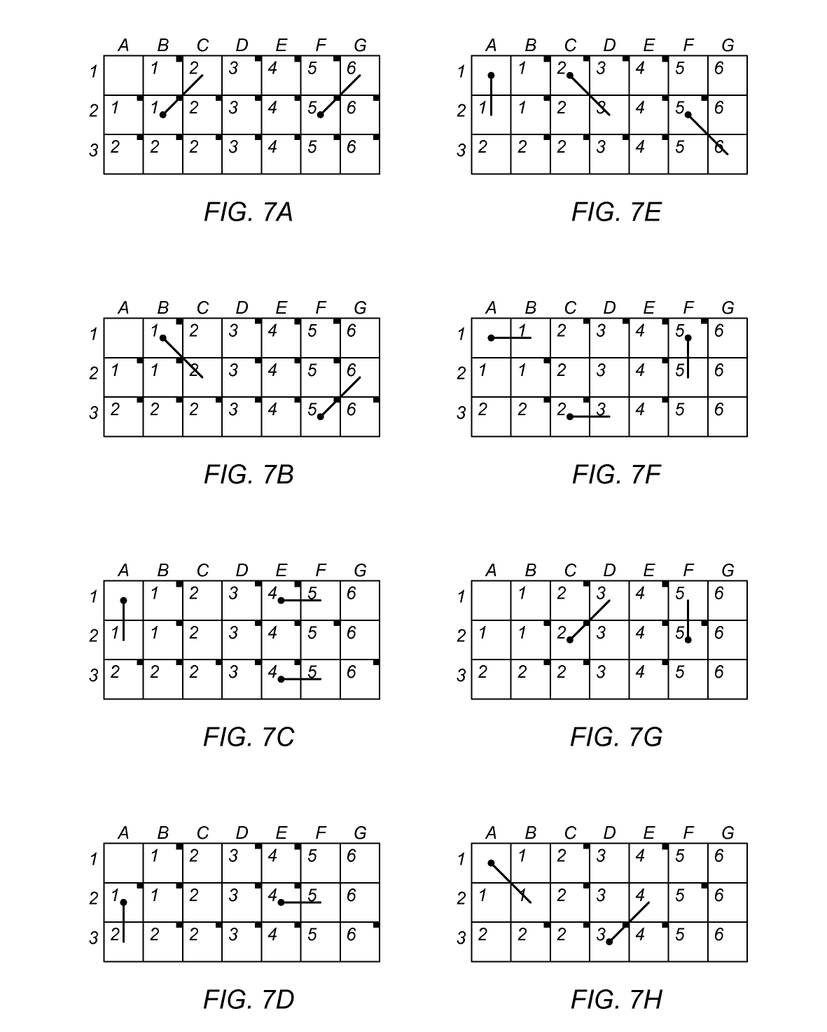

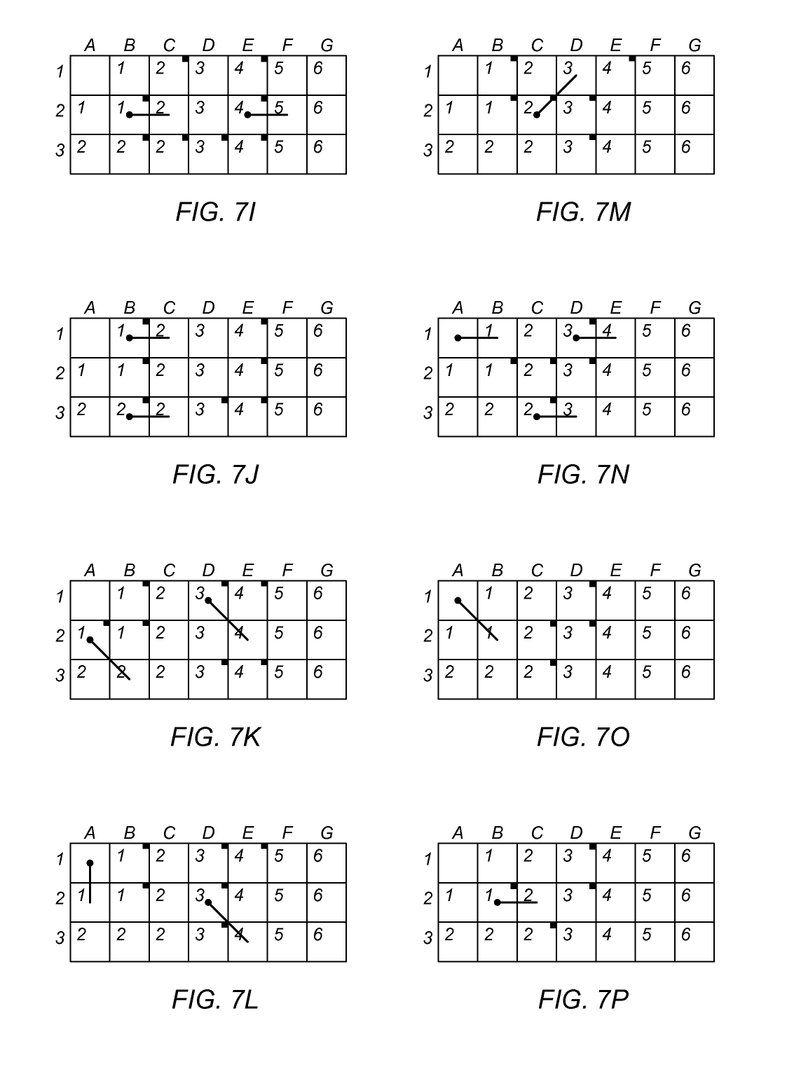

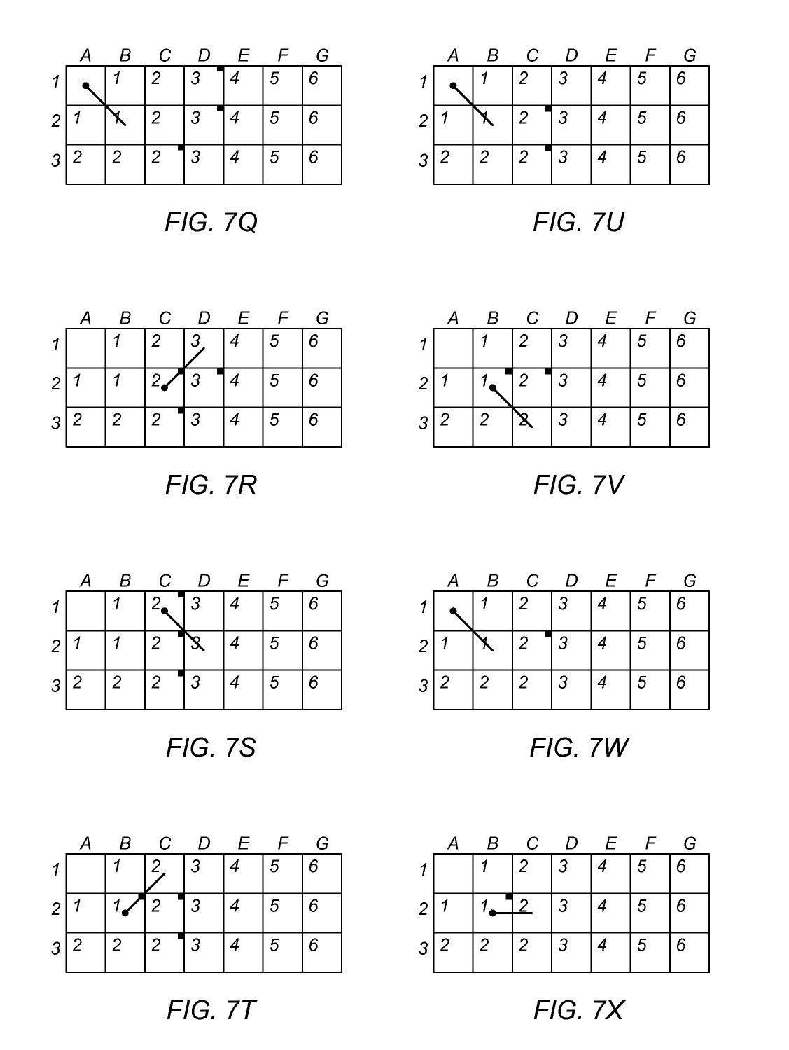

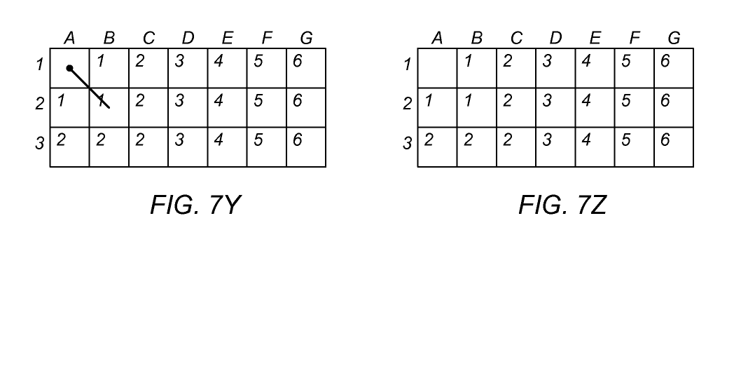

### FIGS. 6A-7Z—Exemplary Mesh Network Establishment and Communication

FIGS. 6A-6K illustrate an exemplary wireless mesh network using the network establishment described in FIG. 4. More specifically, these Figures correspond to a time sequence of broadcasts which establishes the wireless mesh network. In these Figures, dark outlines on squares may represent the storing or buffering of information from a received message. Also, note that these diagrams are simplified and based on the assumption that each node will only communicate with nodes that are physically adjacent or within a certain distance in the grid. In real world implementations, RF adjacency and range may vary considerably (e.g., due to obstructions, reflections, multipath, etc.) from the physical grid distance and adjacencies shown in these simplified diagrams, e.g., nodes may be adjacent from an RF perspective but not from a physical perspective. Despite this simplification for the purposes of illustration, the fundamental principles of operation and message propagation through the mesh remain the same.

As shown in FIG. 6A, the wireless mesh network is composed of a 3×7 array of nodes (e.g., which may correspond to a 3×7 array of solar panels). In this particular network, the node A-1 is the single gateway. In FIG. 6A, the gateway broadcasts a message, which is received by its neighbors, B-1, B-2, and A-2. Accordingly, these neighbors are assigned a hop count of “1”, as shown. These neighbors may store information regarding the gateway, such as its signal strength, hop count (0), backpressure, etc. They may also establish their clock and/or schedule for reporting data based on the message. Further, in response to receive the broadcast message, each of these nodes may broadcast a message to its neighbors.

As shown in FIG. 6B, the node B-1 transmits a broadcast message, which is received by A-1, A-2, B-2, C-1, and C-2. The gateway, A-1 may ignore this message since the hop count is greater than its own (1 versus 1). In one embodiment, the gateway may record B-1 as a neighbor, however. Nodes A-2 and B-2, which are at the same hop level may record B-1 as a neighbor in their routing tables (although in some embodiments, they may ignore the message). In one embodiment, nodes A-2 and B-2 may store information regarding B-1, such as signal strength, back pressure, hop count, etc. Nodes C-1 and C-2 may assign their hop count based on the broadcast of B-1 and store information regarding B-1. Since this message is the first broadcast message they have received, they may assign their hop count to 2, one greater than the hop count indicated by the broadcast message from B-1. Note that although this example shows the dynamic hop count determination of the preferred embodiment, it is also possible for the hop counts for each node to be centrally assigned as part of a network commissioning process.

As shown in FIG. 6C, node C-2 transmits a broadcast message, which is received by B-1, B-2, C-2, D-1, and D-2. Similar to above, nodes B-1 and B-2 may store information indicating that C-1 is a neighboring node. Also similar to above, node C-2 may store information regarding node C-1 in response to the broadcast message. Finally, nodes D-1 and D-2 may assign their hop count to “3” and store information regarding C-1.

In FIG. 6D, nodes A-2 and D-1 may broadcast messages in response to the original gateway message and the message from C-2 respectively. Their neighbors may record information in the manner discussed above. Accordingly, nodes A-3 and B-3 may assign a hop count of “2” while nodes E-1 and E-2 may assign a hop count of “4”.

In FIG. 6E, nodes B-2 and E-2 may broadcast messages. Their neighbors may record information in the manner discussed above. Accordingly, node C-3 may assign a hop count of “2” and nodes D-3, E-3, F-3, F-2, and F-1 may assign a hop count of “5”. Note that this Figure illustrates the simultaneous re-use of bandwidth by showing simultaneous transmissions in separate collision domains by nodes B-2 and E-2. This capability may be key to scalability provided by the network, as it allows the media access control method (usually CSMA/CA in most wireless networks) to automatically and asynchronously distribute traffic throughout the mesh, regardless of the size of the mesh. In fact, the larger the mesh, the more simultaneous broadcast domains are possible and thus the more simultaneous transmissions and the higher the utilization of the mesh network.

In FIG. 6F, nodes A-3, C-3, F-1, and F-3 may broadcast messages. Their neighbors may record information in the manner discussed above. Accordingly, nodes G-1, G-2, and G-3 may assign a hop count of “6”. Note that node D-3 has now updated its hop count to “3” based on the transmission from node C-3.

In FIG. 6G, nodes B-3, D-3, E-1, G-1, and G-3 may broadcast messages. Their neighbors may record information in the manner discussed above. Again, note that the propagation of new information has caused hop count information to be updated: node E-3 has updated its hop count to “4” in response to new hop count information received from node D-3.

In FIG. 6H, nodes D-2 and G-2 may broadcast messages. Their neighbors may record information in the manner discussed above.

In FIG. 6I, nodes C-2 and E-3 may broadcast messages. Their neighbors may record information in the manner discussed above.

In FIG. 6J, node F-2 may broadcast a message. Its neighbors may record information in the manner discussed above.

Finally, the mesh network may be fully established or updated in FIG. 6K.

FIGS. 7A-7Z illustrate the communication method described in FIG. 5 with the wireless mesh network of FIGS. 6A-6K. More specifically, these Figures correspond to a time sequence of communications within the wireless mesh network. Note that in many of these examples, there are multiple simultaneous transmissions in multiple collision domains within the mesh network. Additionally, in these Figures, a black square in the upper right hand corner indicates data is stored in the queue of the node (either its own data or data received from another node), a line indicates a transmission of data, and a circle indicates the destination of the transmission. Initially, every node has data to transmit.

As shown in FIG. 7A, node C-1 may transmit data to node B-2. Node C-1 may have received or generated this data locally (e.g., from a solar panel) and may begin transmission in response to the data or in response to a transmission schedule. Node C-1 may have selected B-2 over node B-1 due to signal strength or backpressure information (since nodes C-1 and C-2 have the same hop count). Similarly, node G-1 may transmit data to F-2. As shown, all nodes except C-1 and D-1 have data stored in their respective queues.

In FIG. 7B, node C-2 may transmit its data to B-1. Additionally, node G-2 may transmit its own data to node F-3. At this point, all nodes except C-1, C-2, G-1, and G-2 have data stored in their respective queues.

In FIG. 7C, node A-2 may transmit its own data to the gateway A-1. Additionally, node F-1 may transmit its data to node E-1. Node F-3 may transmit the data received from G-2, as well its own data to node E-3. At this point, all nodes except, A-2, C-1, C-2, F-1, F-3, G-1, and G-2 have data stored in their respective queues. For the remainder of this discussion, it is to be understood that those nodes without the black rectangle do not have data and that data stored in each queue may include the node's own data and/or data received from other nodes, depending on whether it has previously transmitted its own data or received data from other nodes.

In FIG. 7D, node F-2 may transmit its queue data to E-2. Additionally, node A-3 may transmit its queue data to A-2.

In FIG. 7E, node A-2 may transmit its queue data to the gateway A-1. Additionally, node D-2 may transmit its queue data to C-1. Node G-3 may transmit its queue data to node F-2.

In FIG. 7F, node F-2 may transmit its queue data to node F-1. In this case, due to backpressure (and/or other factors) of nodes E-1, E-2, and E-3, F-2 has selected a node at its own hop count level. Additionally, node D-3 may transmit its queue data to node C-3. Further, node B-1 may transmit its queue data to the gateway A-1.

In FIG. 7G, node D-1 may transmit its queue data to node C-2. Node F-1 may pass its queue data to F-2 (thereby transmitting received data back to F-2), due to collision with D-1 in trying to communicate with E-1 and E-2 (that is, node F-1 failed to receive acknowledgements from attempted transmissions to E-1 and E-2). Note that algorithms may be used to ensure that infinite cycling of data between nodes does not occur. In general, lateral transmissions (to another node with the same hop count) are discouraged and only taken when all moves to a lower hop count have failed.

In FIG. 7H, node E-2 may transmit its queue data to node D-3. Additionally, node B-2 may transmit its queue data to gateway A-1.

In FIG. 7I, node C-2 may transmit its queue data to node B-2. Additionally, node F-2 may transmit its queue data to node E-2.

In FIG. 7J, node C-1 may transmit its queue data to node B-1. Additionally, node C-3 may transmit its queue data to node B-3.

In FIG. 7K, node E-2 may transmit its queue data to node D-1. Additionally, node B-3 may transmit its queue data to node A-2.

In FIG. 7L, node E-3 may transmit its queue data to node D-2. Additionally, node A-2 may transmit its queue data to the gateway A-1.

In FIG. 7M, node D-1 may transmit its queue data to node C-2.

In FIG. 7N, node E-1 may transmit its queue data to node D-1. Additionally, node D-3 may transmit its queue data to node C-3. Further, node B-1 may transmit its queue data to the gateway A-1.

In FIG. 7O, node B-2 may transmit its queue data to the gateway A-1.

In FIG. 7P, node C-2 may transmit its queue data to node B-2.

In FIG. 7Q, node B-2 may transmit its queue data to the gateway A-1.

In FIG. 7R, node D-1 may transmit its queue data to node C-2.

In FIG. 7S, node D-2 may transmit its queue data to node C-1.

In FIG. 7T, node C-1 may transmit its queue data to node B-2.

In FIG. 7U, node B-2 may transmit its queue data to the gateway A-1.

In FIG. 7V, node C-3 may transmit its queue data to node B-2.

In FIG. 7W, node B-2 may transmit its queue data to the gateway A-1.

In FIG. 7X, node C-2 may transmit its queue data to node B-2.

In FIG. 7Y, node B-2 may transmit its queue data to the gateway A-1.

Finally, in FIG. 7Z, a complete round of transmissions may be completed.

Note that while FIGS. 6A-6K and FIGS. 7A-7Z have been described separately, the operations may occur concurrently. For example, before the broadcast messages of FIGS. 6A-6K have completed in the mesh network, the data unicast shown in FIGS. 7A-7Z may begin (once hop count values have been established for the nodes involved in the unicast messages). Where the mesh network has already been established, the broadcasts of 6A-6K may be used for updating various values. In the mean time, however, the unicast messages of data may continue. Thus, the broadcasting method of FIG. 4 and the communication method of FIG. 5 may be performed at the same time.

### FIGS. 8A-8E—Exemplary Node Selection

FIGS. 8A-8E illustrate exemplary tables corresponding to node selection for one particular embodiment.

More specifically, FIG. 8A illustrates an exemplary wireless mesh network (corresponding to the one discussed above, regarding FIGS. 6A-7Z.

FIG. 8B illustrates an exemplary table that may correspond to the node E-3 of FIG. 8A. As shown, the table includes entries for nodes E-2, E-1, D-3, D-2, D-1, C-3, C-2, and C-1. Each of these entries includes hop count information, queue length information, signal strength information (received signal strength indicator (RSSI) values) and time to live (TTL) values.

In one embodiment, the sort order for selecting a desired neighbor may be determined according to the following rules (e.g., with the following priority, though others are envisioned):

1) shortest number of hops to Gateway, with a lateral transmission (to a node with the same hop count) considered last;

2) shortest queue length; and

3) strongest RSSI (in this case, highest number, less negative is better).

FIG. 8C illustrates the table of 8B, but sorted according to the aforementioned rules. More specifically, the sorted order in FIG. 8B may be used to select the best address (neighbor node) to use for sending a packet towards the gateway. As shown in FIG. 8C, the neighbors are now sorted according to the following priority: D-2, D-3, D-1, C-3, C-1, C-2, E-1, and E-2. Note that a new table may not be necessary, instead, a new field (e.g., the “sort” field) may be used to prioritize existing entries, although in FIG. 8C, the list of entries has been sorted according to the sort field.

Additionally, note that the table in FIG. 8C/8D may be updated upon receipt of an incoming packet. In this example, a new neighbor may replace any unpopulated entry or entry with a TTL value of 0. If there are no entries meeting these conditions, then the new neighbor may replace an existing entry provided the new neighbor represents a better route as defined by the sort criteria. If the neighbor already exists in the table, then the entry for the neighbor may be updated to reflect current information about the neighbor and the TTL may be reset to an initial value indicating that it is still a valid neighbor.

The TTL information for a neighbor table entry may be decremented towards zero upon receipt of a broadcast Time Sync message originated from the gateway. When TTL reaches zero, it may indicate that no message from the neighbor has been received in sufficient time to consider the neighbor no longer active and suitable for replacement in the table.

FIG. 8D illustrates an exemplary new Time Sync message from node B3 of FIG. 8A. As address B3 does not appear in the existing neighbor table as shown in FIG. 8B, the table may be searched to locate an entry with a TTL of 0. As shown, the 7^{th} entry (corresponding to node C-2) of FIG. 8B has a TTL of zero. Accordingly, it may then be replaced with the information from the newly received packet (corresponding to node B-3). Additionally, the TTL of all other entries may be decremented in response to the received Time Sync message. FIG. 8E shows a possible result of this received message.

Thus, FIGS. 8A-8E illustrate exemplary tables and rules that may be used for node selection, according to one embodiment.

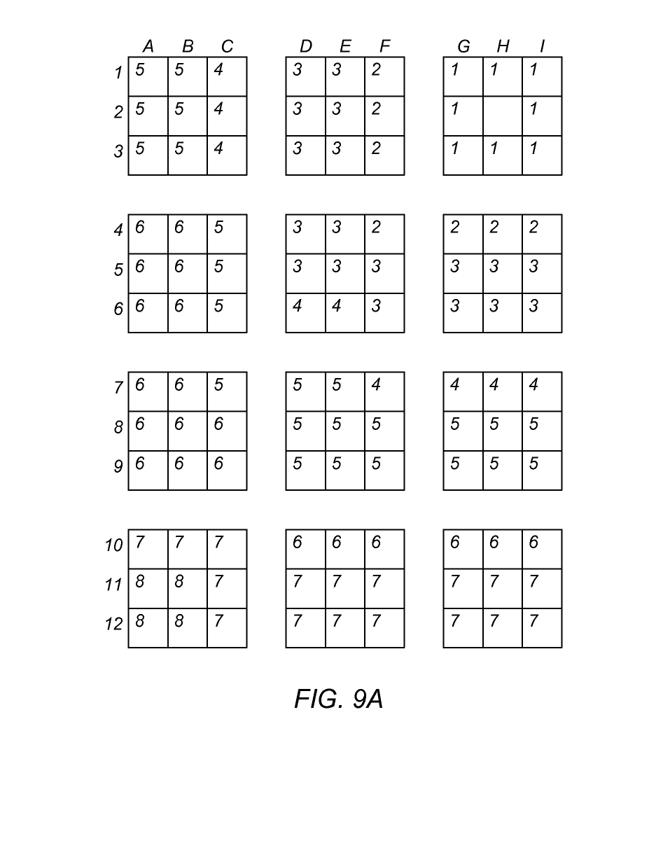

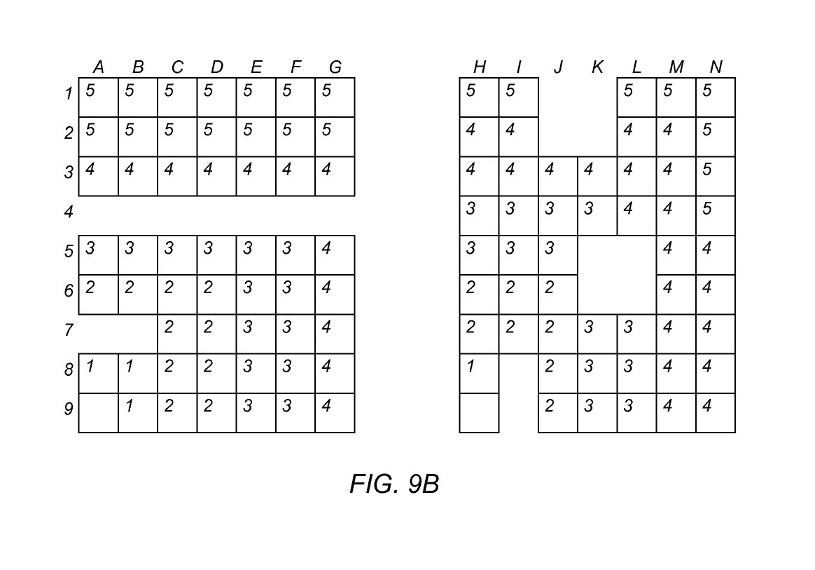

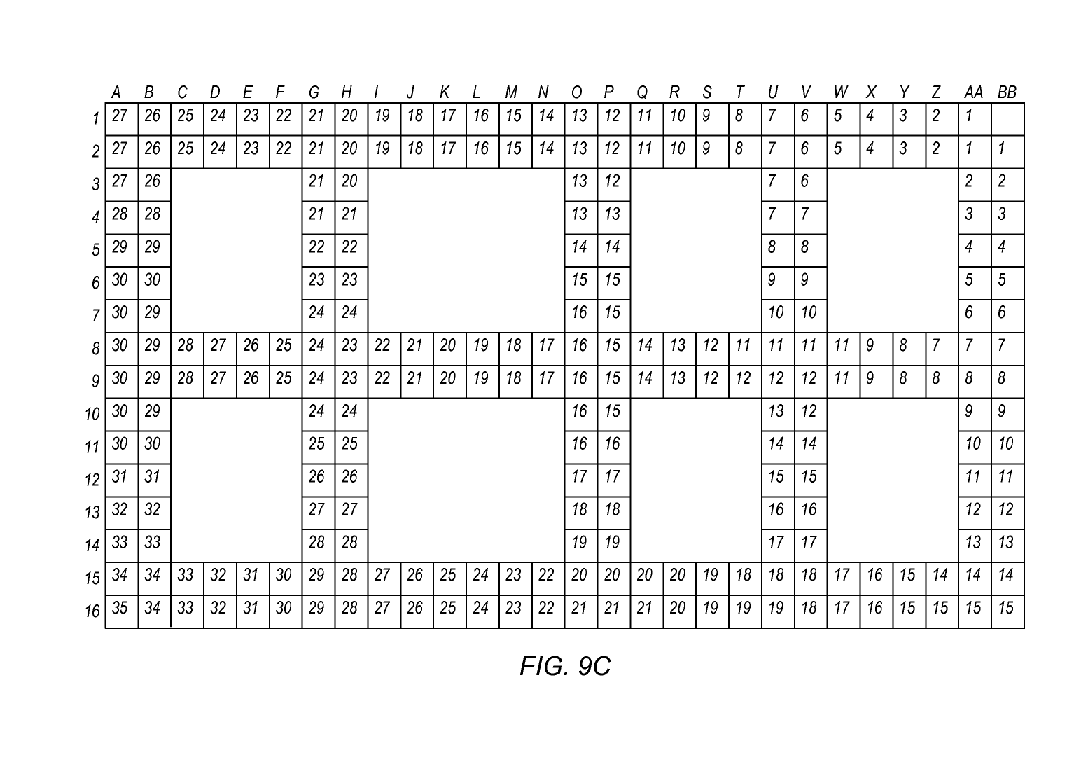

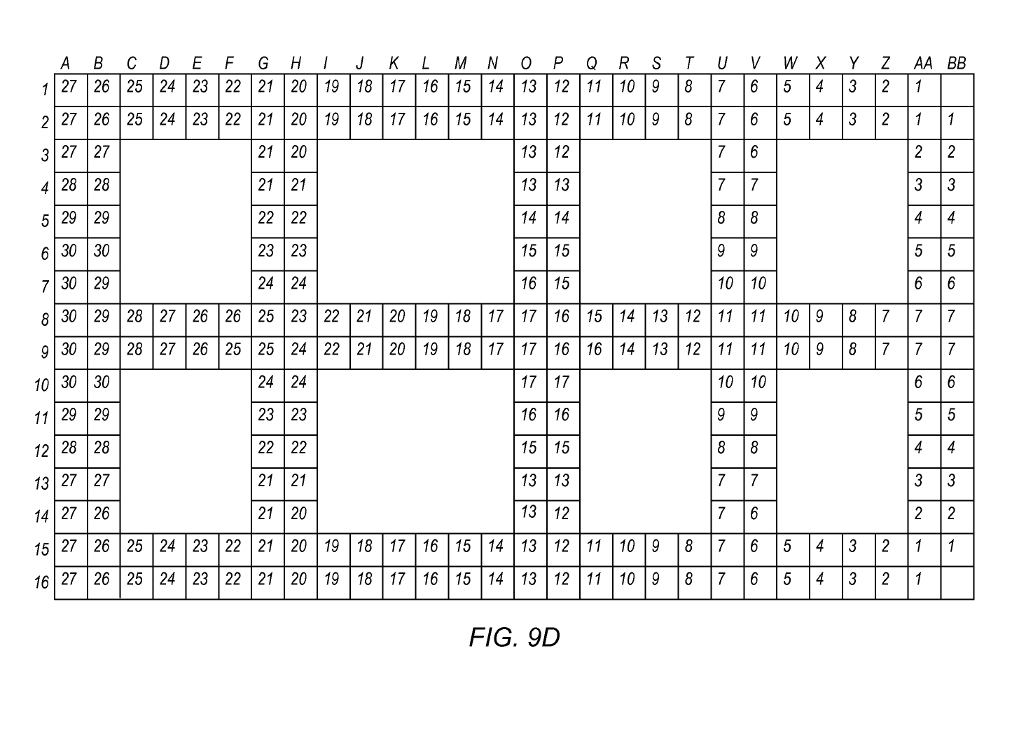

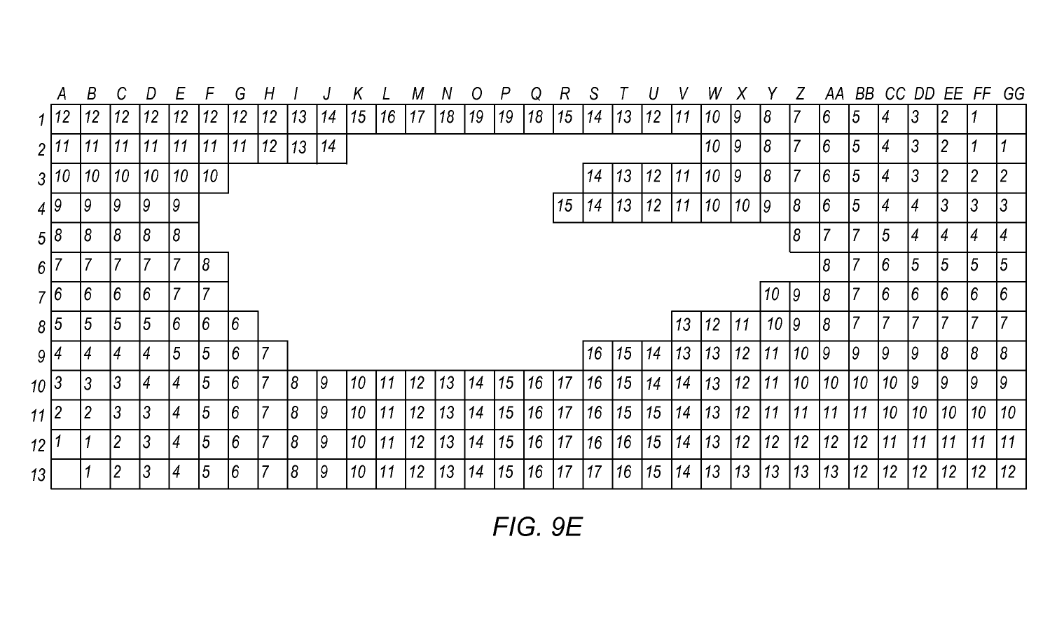

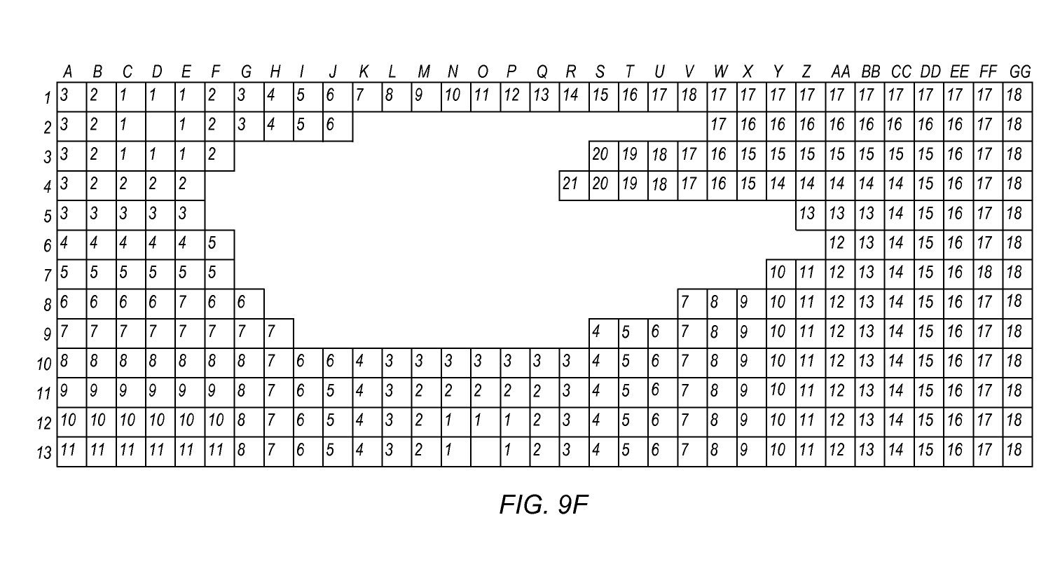

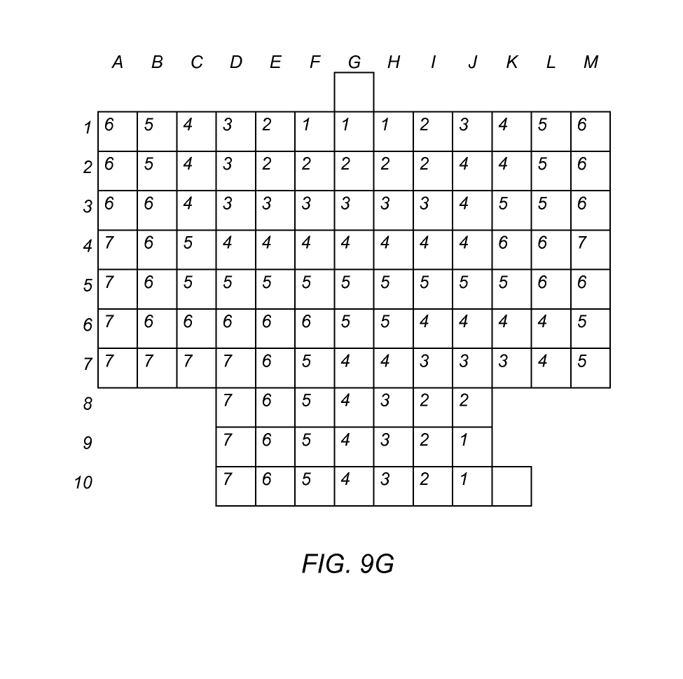

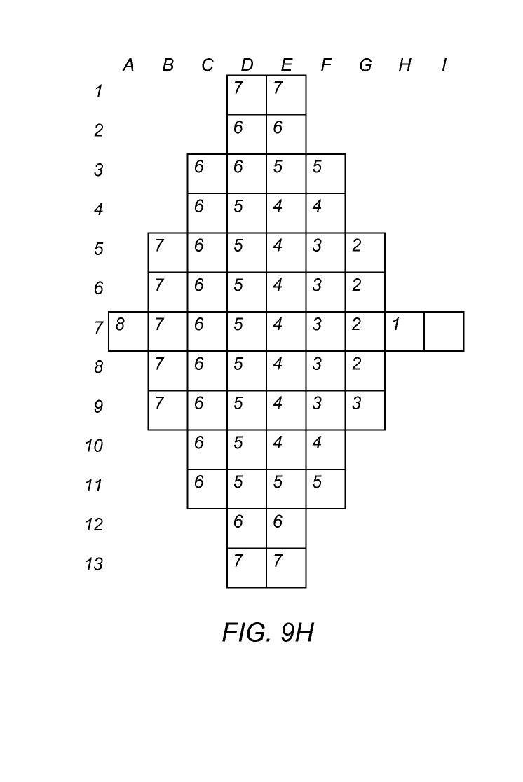

### FIGS. 9A-9H—Exemplary Wireless Mesh Networks

FIGS. 9A-9H illustrate various exemplary wireless mesh networks.

More particularly, in the wireless mesh network of FIG. 9A, the wireless mesh network comprises a 3×4 of 3×3 nodes. In this particular instance, the gateway is located at H-2, and the hop counts are indicated for each node in the Figure. Note that the broadcast domain for this set of Figures is larger, at two squares, than in previous examples.

In the wireless mesh network of FIG. 9B, the wireless mesh network has three different sections. A first gateway is located at H-9 and a second gateway is located at A-9. The hop counts are indicated for each node. As shown, the transmission power of the nodes is somewhat larger than the immediate neighbors in the array (e.g., A-1 is a hop count of 5, as is A-2, which may both be in range of broadcasts from A-3). Additionally, the nodes from A-1 to G-9 have hop counts corresponding to the gateway at A-9 and nodes H-1 through N-9 have hop counts corresponding to the gateway at H-9.

FIG. 9C illustrates an exemplary wireless mesh network having many gaps or holes in a 16×28 array. In this instance, there is a single gateway at BB-1, and the hop counts of the remaining nodes are indicated for each node, illustrating the establishment of hop count based routing flows for the entire network.

FIG. 9D illustrates the exemplary mesh network of 98C, except with an additional gateway at BB-16. The hop counts of the remaining nodes are indicated for each node.

FIG. 9E illustrates an exemplary wireless mesh network with a gateway at GG-1 and another gateway at A-13. The hop counts of the remaining nodes are indicated for each node.

FIG. 9F illustrates the exemplary wireless mesh network of FIG. 9E with a gateway at D-2 and O-13. The hop counts of the remaining nodes are indicated for each node.

FIG. 9G illustrates an exemplary wireless mesh network having a gateway at G-0 and K-10. The hop counts of the remaining nodes are indicated for each node.

Finally, FIG. 9H illustrates an exemplary wireless mesh network having a gateway at I-7. The hop counts of the remaining nodes are indicated for each node.

### Further Embodiments

The following provides various embodiments which may be used in conjunction with the systems and methods described above.

Addressing

Addressing may be performed in a variety of manners. In one embodiment, MAC ID addressing may be used. MAC ID addressing may be easier to implement, e.g., using the existing wireless protocols, such as 802.15.4. However, using MAC ID addressing, messages to groups of nodes may have to be implemented using a message to each individual node in the group, rather than sending a single message to be interpreted by all nodes in the target group.

In another embodiment, however, logical addressing may be used. Logical addressing may be particularly desirable when attempting to address nodes hierarchically. For example, for a building having nodes on different floors, logical addressing may be able to address the entire building, individual floors, individual rooms, etc. using logical addresses rather than individual addresses of each node (although this is still possible). Similarly, for a solar panel array, messages may be directed to arrays of panels, strings of panels, individual panels, etc. Thus, with logical addressing, the messages can be sent to nodes using arbitrary hierarchies. The logical addressing may be implemented using a certain number of bits per hierarchy within an address field, although other embodiments are envisioned.

Priority Messages

In some embodiments, some messages may have a higher priority than other messages. For example, messages originating from the gateway (e.g., broadcast messages, such as those described in FIG. 4, messages to groups of nodes or individual nodes, etc.) may generally have a higher priority than transmissions to the gateway. Broadcast messages may have a higher priority than unicast messages. System or configuration messages may have a higher priority than measurement data messages.

Priority messaging may be implemented in a variety of manners. For example, there may only be two types of messages, priority or non-priority. In this case, only certain types of messages may be marked as a priority message (e.g., within the message header). When a node is selecting which data to send from its queue, it may select those messages that are marked as priority first. Alternatively, each message may have a priority value, allowing for multiple tiers of priority, and messages may be selected based on a ranking of the priority value.

Asymmetric Power Levels for Wireless Transmissions

In one embodiment, various wireless transmissions may be performed with different power levels. For example, it is generally important that if an acknowledgement is sent, it be received by the transmitting node, since the transmitting node will retransmit the data if no acknowledgement is received. Accordingly, acknowledgement messages may be transmitted with a higher power level than typical data transmission messages. Similarly, broadcast messages or priority messages may be transmitted with a higher than default power level, as desired. According to various embodiments, appropriate power levels may be set by configuration (e.g., on a per message type basis) or in an automatic or dynamic fashion, as desired.

Bridging Longer Distances Between Neighboring Nodes

In some embodiments, various ones of the nodes in the wireless mesh network may be distanced further apart than the majority of the nodes in the wireless mesh network. For example, in the case of a solar panel array, there may be a first set of panels in a first section of a roof and a second set of panels in a second section of a roof (or on another roof). However, a gateway may not be present for both of the sections, e.g., it may be present in the first section. Accordingly, at least two of the nodes may have to transmit at a higher power in order to bridge the distance between the two sections. In some embodiments, these nodes may be referred to as “super nodes” or “high power nodes”.

The higher power transmissions from these nodes may be handled in a number of ways. For example, the nodes may transmit less often, since the higher power transmissions may interfere with many more nodes in the mesh network than normal transmissions (e.g., extending well beyond the distance of typical neighboring nodes). In one embodiment, to allow for this less frequent transmission, the high power nodes may have a larger queue or memory for storing information. Super nodes may be configured in groups of two or more to create a higher power sub-network to allow path diversity in connecting discontinuous regions of the mesh network. Super nodes may be configured by manual designation of super node groups and super node power levels, or via an automated process in which the maximum extent of each node is determined automatically, and then backed off to an appropriate “default” power level (which may itself be set to suit each particular region of the mesh).

As another possibility, the high power nodes may utilize a different spectrum or transmission method for those transmissions. For example, the high power nodes may have a second radio or wireless hardware which transmits in a different frequency or according to a different protocol that does not interfere with other transmissions in the wireless mesh network. In further embodiments, the two nodes may simply be connected in a wired fashion, which would not interfere with wireless transmissions.

These embodiments may be particularly useful for mesh networks, such as shown in FIGS. 8A and 8B. For example, one or more of the nodes from A-3 to G-5 of FIG. 8B may be configured as high power nodes.

Acknowledgements

In some embodiments, nodes of the wireless mesh network may use a wireless protocol which is implemented at least partially in hardware. For example, low level functions of the wireless protocol may be implemented in the wireless hardware of the wireless nodes. In one specific example, the wireless hardware may implement a portion of the 802.15.4 protocol and may automatically acknowledge all received messages. However, it may not be desirable for the wireless nodes to always acknowledge received messages. For example, if the wireless node has a full queue, cannot store the data of the message, or should not otherwise handle the data (e.g., because backpressure or queue length is above a threshold). In these embodiments, the wireless protocol (e.g., in software) may be able to modify the transmission power of the acknowledgement even if it cannot suppress the actual acknowledgement itself. Accordingly, instead of stopping the acknowledgement from occurring, the transmission power of the acknowledgement may be reduced to 0 or a negligible level. Accordingly, the node that transmitted the message will not receive the acknowledgement.

Firmware/Software Updates

In some embodiments, updates may be provided to nodes in the mesh network, e.g., to update firmware and/or software of the nodes. In one embodiment, the updates to the nodes may be initially broadcast via a plurality of messages, each having a segment of an image of the update. More specifically, the update may be sliced into segments and those segments may be broadcast using messages. Once the update has been sent to all the nodes in the mesh network, a commit command may be broadcast to instruct individual nodes, groups of nodes, or all of the nodes to apply the update.

In some embodiments, there may have been errors in one or more of the messages, such that one or more nodes do not have a complete update image. Accordingly, these nodes may request missing portions of the update image. For example, the nodes may apply a bitmask to determine which segments of the firmware have been correctly received and which portions are missing. These nodes may then provide a request for the missing portions, e.g., using a unicast message directed to the gateway. The gateway may then respond with unicast message(s) to the individual nodes or groups of nodes to provide the missing portions. In some embodiments, this procedure may be performed in response to the commit command, when a missing segment is identified (e.g., because of an out of order message or segment), or in response to a request by the gateway to check the update image.

Other methods for performing updates are also envisioned.

Message Headers

As indicated above, the mesh network may be implemented using a wireless protocol based on 802.15.4. The 802.15.4 protocol (and potentially other protocols) dictates a uniform message header length for both broadcast and unicast messages. However, when broadcasting, portions of the header are not used (since the message is directed to all nodes). Accordingly, the nodes may use a wireless protocol that implements the same header length and general format, but add additional information to various ones of the messages, e.g., the broadcast messages, which was previously unused.

In more detail, typical broadcast addressing in 802.15.4 requires a broadcast destination address using short addressing. This is a shorter address than the full address that is used in unicast messages, resulting in a difference in the length of the header which changes the offset to the data payload of the corresponding packet.

An addressing mode within the 802.15.4 specification allows designated coordinator nodes to hear all unicast messages within a specific PAN ID. This mode eliminates the destination address field from the message header. In one embodiment, by placing the broadcast address before the data payload on these messages, the resulting packet length is the same as the unicast message and the offset to the data payload remains constant. This process may simplify the parsing of messages and yield a speed improvement in network throughput.

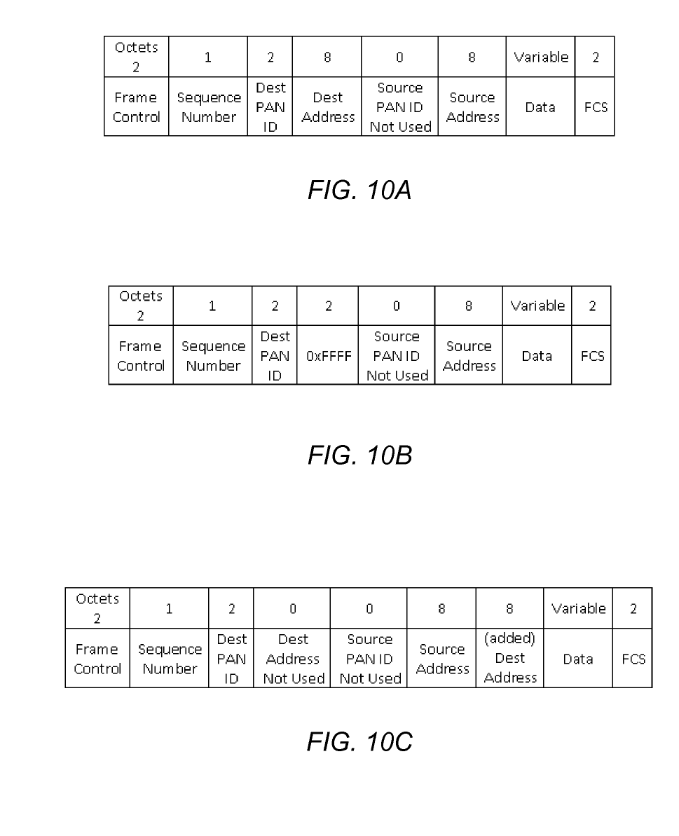

FIGS. 10A and 10B illustrate existing 802.15.4 MAC header descriptions. More specifically, FIG. 10A corresponds to a unicast header with long source and destination addressing. FIG. 10B corresponds to a typical broadcast header with long source addressing.

FIG. 10C illustrates a modified broadcast header with long source and destination addressing, according to one embodiment. By utilizing the coordinator addressing mode, the packet header length may remain constant with the source and destination addresses being swapped. Upon receipt of this packet, the addresses may be swapped back to represent a normal unicast addressing format allowing all processing of the packet to utilize the same format for messages.

Late or Duplicate Messages

In some embodiments, nodes may be configured to ignore duplicate messages or messages that are later than a threshold amount (e.g., based on the current time and time indicated by the message). By implementing this feature, the mesh network may avoid messages that are stuck in indefinite transmissions (e.g., broadcast messages which are repeatedly transmitted or broadcast among a subset of the nodes in the mesh network). One embodiment to prevent such “routing loop” behavior is for each node to keep a buffer of recently received packets and/or packet identifiers, and refuse to forward any packet that has previously passed through the node, as determined by comparison of that packet to the contents of this “recently seen” buffer.

Establishing a New Node without a Gateway or Synch Message

There is not necessarily a need in establishing a new node in the network to have the gateway send out periodic time sync/hop count route probe broadcast before it can communicate. While such a process may certainly speed and simplify the process, it isn't, strictly speaking, necessary. However, in the following embodiment, such a process may not be necessary: A node may initially join the network (e.g., after waking from a sleep state or after installation), but without having received a broadcast message from the gateway, may not have a defined hop count. Accordingly, the new node may receive messages transmitted by neighboring nodes (e.g., during the normal course of operation of the mesh network) and may send its data to the node with the best combination of low hop count, low backpressure, and high signal strength. In this transmission, though, since the new node does not yet have a valid hop count, the new node can set its own hop count (both advertised hop count and source hop count) to a maximum value (255 in our current implementation) that will not place it in the routing path for any adjacent nodes. The new node can continue to transmit in this way, with its data still being delivered properly through the mesh, until the next time sync/route probe broadcast, at which time it update its hop count in the usual way.

### Advantages

Advantages of the present embodiments over prior art include several significant capabilities and attributes. First, unlike other scalable mesh networks, since nodes in the network generally do not store information about anything other than a few surrounding neighboring nodes, there is no practical limitation to network size. Prior implementations of highly scalable mesh networks have required at least one node in the network to have enough memory to store information about all other nodes in the network. This very low requirement for mesh node memory also has an additional advantage in that regardless of network size, all nodes can be the same, that is, there may not be a requirement for higher capacity nodes with larger memory or more processing power, and consequently no difficulties into determining their number and placement of nodes with a larger capacity. This feature dramatically simplifies network design, implementation, and configuration.

Second, almost all prior mesh networking protocols consume an increasing amount of mesh bandwidth for routing and mesh management as the size of the network grows. Embodiments described herein may use a fixed amount of bandwidth to perform these functions regardless of network size. Further, the amount of bandwidth used for routing and mesh management functions can be adjusted for the rate and level of change expected in a given environment, e.g., a deployment in a largely fixed environment expecting nodes to join or leave the network only infrequently can easily consume only a tiny fraction of one percent of the mesh bandwidth for all routing and mesh management and coordination, comparing favorably with prior art mesh networks that in a highly scalable configuration can keep such traffic below a fixed level of a few percent at best.

Additionally, because embodiments discussed herein may not rely on source routing (which requires not only memory for keeping, but also frame space for transmitting a relatively large number of intervening network addresses), it is readily compatible with, e.g., and ideally suited for, low power wireless networks with very small frame sizes, such as the 128-byte frame size used by the IEEE 802.15.4 standard. In addition, because these embodiments may effectively allow unlimited reuse of bandwidth via multiple collision domains, in networks of any significant size real world performance closely approaches the maximum theoretical bandwidth of the wireless link itself Lastly, aggregate performance of the network can be easily improved by simply adding additional mesh gateways to allow messages to “drain” from the mesh faster, allowing the network to easily scale for both size and performance.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A method for establishing routing information in a wireless mesh network, the method comprising:
a gateway in the wireless mesh network broadcasting a first wireless message to a first set of nodes in the wireless mesh network, wherein the first set of nodes are neighboring nodes to the gateway;
in response to the first wireless message, the first set of nodes storing first hop count information based on the first wireless message received from the gateway;
in response to the first wireless message, the neighboring nodes each broadcasting a second wireless message to a second set of nodes in the wireless mesh network, wherein the second set of nodes are neighboring nodes to the first set of nodes;
in response to the second wireless messages, the second set of nodes storing second hop count information based on the received messages from the first set of nodes, wherein the second hop count information indicates a greater hop count than the first hop count information;
wherein the first hop count information and the second hop count information are used to establish routes from nodes to gateways in subsequent communications in the wireless mesh network.

2. The method of claim 1, wherein the wireless message from each node comprises queue information.

3. The method of claim 1, further comprising:
the second set of nodes storing queue information based on the received messages from the first set of nodes, wherein each node is configured to use the queue information and the hop count information to determine routes for future data communication.

4. The method of claim 1, further comprising:
the second set of nodes storing signal strength information based on the received messages from the first set of nodes, wherein each node is configured to use the signal strength information and the hop count information to determine routes for future data communication.

5. The method of claim 1, wherein storing hop count information and broadcasting wireless messages is performed repeatedly by each set of wireless nodes until all nodes in the wireless mesh network have received a wireless message.

6. The method of claim 1, wherein said broadcasting the first wireless message, said storing the first hop count information, said broadcasting the second wireless message, and said storing the second hop count information is performed periodically during operation of the mesh network.

7. The method of claim 1, wherein a second gateway is present in the wireless mesh network, wherein said broadcasting the first wireless message, said storing the first hop count information, said broadcasting the second wireless message, and said storing the second hop count information is also performed corresponding to the second gateway.

8. A wireless node in a wireless mesh network, wherein the wireless node comprises:
wireless communication circuitry, configured to perform wireless communication in the wireless mesh network; and
processing hardware coupled the wireless communication circuitry, wherein the processing hardware is configured to operate with the wireless communication circuitry to:
receive a first plurality of wireless messages from a first set of nodes in the wireless mesh network, wherein the wireless node is a neighboring node to the first set of nodes in the wireless mesh network, wherein each wireless message comprises hop count information of the respective node broadcasting the respective wireless message;
in response to the first plurality of wireless messages, store hop count information for the wireless node, wherein the hop count information for the wireless node indicates a greater hop count than the hop count indicated in the hop count information of at least one of the first plurality of wireless messages;
in response to the first plurality of wireless messages, broadcast a second wireless message to a second set of nodes in the wireless mesh network, wherein the second wireless message comprises hop count information indicating the hop count of the wireless node;
wherein the hop count information of the wireless nodes in the wireless mesh network is used to establish routes from nodes to gateways for communications in the wireless mesh network.

9. The wireless node of claim 8, wherein wireless messages from each node comprises queue information.

10. The wireless node of claim 8, wherein the first plurality of wireless messages comprises queue information of the respective wireless node, wherein the processing hardware is further configured to:
store the queue information of at least one of the first set of nodes based on the received messages from the first set of nodes, wherein the wireless node is configured to use the queue information and the hop count information to determine routes for future data communication.

11. The wireless node of claim 8, wherein the processing hardware is further configured to:
store signal strength information corresponding to at least one of the first set of nodes based on the received messages from the first set of nodes, wherein the wireless node is configured to use the signal strength information and the hop count information to determine routes for future data communication.

12. The wireless node of claim 8, wherein said broadcasting wireless messages and storing hop count information is performed repeatedly by each set of wireless nodes until all nodes in the wireless mesh network have received a wireless message.

13. The wireless node of claim 8, wherein said receiving the first plurality of wireless messages, said storing hop count information, and said broadcasting the second wireless message is performed periodically during operation of the mesh network.

14. A non-transitory, computer accessible memory medium storing program instructions for configuring a node in a wireless mesh network, wherein the program instructions are executable by a processor to:
receive a first plurality of wireless messages from a first set of nodes in the wireless mesh network, wherein the wireless node is a neighboring node to the first set of nodes in the wireless mesh network, wherein each wireless message comprises hop count information of the respective node broadcasting the respective wireless message;
in response to the first plurality of wireless messages, store hop count information for the wireless node, wherein the hop count information for the wireless node indicates a greater hop count than the hop count indicated in the hop count information of at least one of the first plurality of wireless messages;
in response to the first plurality of wireless messages, broadcast a second wireless message to a second set of nodes in the wireless mesh network, wherein the second wireless message comprises hop count information indicating the hop count of the wireless node;
wherein the hop count information of the wireless nodes in the wireless mesh network is used to establish routes from nodes to gateways for communications in the wireless mesh network.

15. The non-transitory, computer accessible memory medium of claim 14, wherein wireless messages from each node comprises queue information.

16. The non-transitory, computer accessible memory medium of claim 14, wherein the first plurality of wireless messages comprises queue information of the respective wireless node, wherein the program instructions are further executable to:
store the queue information of at least one of the first set of nodes based on the received messages from the first set of nodes, wherein the wireless node is configured to use the queue information and the hop count information to determine routes for future data communication.

17. The non-transitory, computer accessible memory medium of claim 14, wherein the program instructions are further executable to:
store signal strength information corresponding to at least one of the first set of nodes based on the received messages from the first set of nodes, wherein the wireless node is configured to use the signal strength information and the hop count information to determine routes for future data communication.

18. The non-transitory, computer accessible memory medium of claim 14, wherein said broadcasting wireless messages and storing hop count information is performed repeatedly by each set of wireless nodes until all nodes in the wireless mesh network have received a wireless message.

19. The non-transitory, computer accessible memory medium of claim 14, wherein said receiving the first plurality of wireless messages, said storing hop count information, and said broadcasting the second wireless message is performed periodically during operation of the mesh network.

20. A method for establishing routing information in a wireless mesh network, the method comprising:
a wireless node in the wireless mesh network receiving a first plurality of wireless messages from a first set of nodes in the wireless mesh network, wherein the wireless node is a neighboring node to the first set of nodes in the wireless mesh network, wherein each wireless message comprises hop count information of the respective node broadcasting the respective wireless message;
in response to the first plurality of wireless messages, the wireless node storing hop count information for the wireless node, wherein the hop count information for the wireless node indicates a greater hop count than the hop count indicated in the hop count information of at least one of the first plurality of wireless messages;
in response to the first plurality of wireless messages, the wireless node broadcasting a second wireless message to a second set of nodes in the wireless mesh network, wherein the second wireless message comprises hop count information indicating the hop count of the wireless node;
wherein the hop count information of the wireless nodes in the wireless mesh network is used to establish routes from nodes to gateways for communications in the wireless mesh network.
